(19) United States
(12) Patent Application Publication
(10) Pub. No.: US 2020/0279211 A1
(43) Pub. Date: Sep. 3, 2020

(54) IDENTIFICATION MODULE AND SUBSYSTEM INTERACTING IN AN END-TO-END TRACK AND TRACE SYSTEM

(71) Applicant: Robert Gillett, Studio City, CA (US)

(72) Inventor: Robert Gillett, Studio City, CA (US)

(21) Appl. No.: 16/289,352

(22) Filed: Feb. 28, 2019

(51) Int. Cl. G06Q 10/08; G06K 7/14; G06Q 30/06

(52) U.S. Cl. CPC G06Q 10/087; G06Q 10/0838; G06Q 30/0609; G06K 7/1413

(57) ABSTRACT

An identification module and a subsystem including the identification module interact with an end-to-end track and trace system that traces a product or product component from its origin to an ultimate delivery recipient. An identification module comprises a live camera in a portable interactive device and an application that decodes identification indicia, particularly barcodes, directly from the live image sensor array rather than decoding from a still image. A CCD image sensor array produces a string of code characters in response to illumination of pixels. A camera in the scanner is operated at a frame rate that is a multiple of a nominal imaging frame rate of the camera. The subsystem translates the identification into an output provided to the track and trace system. The system reports details of deliveries to the track and trace system. Accountability information at the end of the track and trace system, maintains efficacy and accuracy of all the prior steps in the system.

### FIELD

The present subject matter relates generally to a module and subsystem for extracting coded information from a credential to authenticate a recipient's identity and integration of the module and subsystem to maintain the integrity and operability of an end-to-end track and trace system.

### BACKGROUND

Tracking and traceability systems maintain a chain of custody and accountability for amounts of sensitive products. For example, with the recent legalization of cannabis in many states, the need has been heightened for end-to-end tracking, also known as seed-to-sale tracking. Tracking refers to a system that is designed to follow a product through all stages of its manufacturing process, distribution, and retail sales. Traceability is the ability to trace the history of a product based on its serial number or a badge number. Information associated with the item, such as the serial number or badge number, is encoded on a readable medium. Many different fields may be provided. A common form of encoding is done with the barcodes. Radio Frequency Identification (RFID) tags are useful in carrying encoded information and may be associated with items that should not be touched or which cannot carry a barcode label.

A significant embodiment of a “track and trace” reporting system is known as METRC (Marijuana Enforcement Tracking Reporting). This system was originally developed in Colorado and is now used in several states. The present subject matter is particularly well-suited for the retail sales phase of tracking. However, the present subject matter is not limited to a particular system. The track and trace system needs to account for virtually every gram of marijuana plant from its planting as a seedling through manufacturing into a product and delivery to a recipient. If the integrity of any one phase of the track and trace system is compromised, the value of the track and trace system is greatly diminished. The accountability at the retail phase of the system is necessary to complete tracking. If the delivery phase is defective, the value of tracking in the phase in which the cannabis seedling is planted can be lost. Each phase of the track and trace system interacts in order to ensure the efficacy and reliability of the entire system.

A retail phase comprises a dispensary's receiving stock from a manufacturer, selling the product, and delivering the product. It is important to identify and authenticate a recipient. A recipient must demonstrate being of age. Some recipients may be eligible for privileges reserved to medical marijuana users. This status must also be validated. Sale of the product may include delivery rather than a customer receiving the product at the dispensary. The delivery service must document deliveries and recipient identities at the end of the sale phase of the track and trace system. Delivery services do not normally carry sophisticated equipment that may be suited for and used in a permanent location such as a dispensary. Delivery services may enter areas where Internet or other telecommunication service is not available. Difficulty of compliance with regulations is significantly increased when a delivery cannot be completed using compliant system instrumentation.

Barcodes encoded with required data are used for transport, identification cards, and inventory management, for example. Commonly used barcodes are the traditional one-dimensional parallel line barcode and the two-dimensional QR code. A widely used barcode protocol is PDF417. PDF417 is a stacked linear barcode symbol format defined by ISO standard 15438. One form of barcode reader suited for permanent location at a retail business is the infrared scanner. The infrared scanner is a dedicated device that does not perform other functions beyond reading barcodes. Sophisticated, dedicated scanners are well-suited for full-time, high-volume delivery services such as overnight carriers. However, deliveries made on behalf of a dispensary may be executed by individuals whose vehicles are not dedicated to delivery and which are not equipped with dedicated devices.

Android smartphones and tablet PC's have more powerful cameras than most of the traditional 2D barcode scanners currently in use. These cameras are used to capture images of barcodes. Smartphone cameras have the primary function of performing as digital cameras. The smartphone cameras are not designed for barcode scanning. Therefore, the images they produce are not optimized for barcode decoding. In many instances, barcode illumination is unsatisfactory. In order to achieve accurate results, the barcode decoding software must compensate for inadequacies of decoding a barcode image.

Even so, a smartphone is better suited to non-dedicated service than a dedicated scanner. A widely used technique is performed by using a camera in a smartphone or other portable interactive device and producing an image of the barcode. Decoding is performed by analyzing the image. First producing an image of a barcode and then converting the code into the encoded intelligence is a process currently in use. This form of decoding generally requires an Internet connection so that barcode images may be compared to standards that reside in a server. Companies such as 2DTG offer mobile barcode decoders and decoding libraries adapted for portable interactive devices equipped with rear view cameras. Operating systems include Android 4.x and higher. Barcode decoding libraries include Data Matrix (Enterprise Edition), QR Code, 1D Barcodes, Aztec Code, and PDF417.

A conventional way of reading a barcode from a portable interactive device is accomplished by loading an app into a smartphone. Many apps are available via Google Play or the iPhone store. Well-known apps include i-nigma, NeoReader, Quick Scan, and Zapper. These apps are subject to the limitations of the process of decoding by analyzing an image. Apps used within a METRC system need to pass a coding test to assure compliance with state requirements.

One prior art identity verification and data management system is disclosed in the U.S. Pat. No. 9,286,631. An image of a barcode of a driver's license is taken with a digital camera of an Internet-enabled mobile device. The image is processed using a decoding module to identify a quantity of identification information stored in the barcode. This information is compared to a quantity of stored data. A comparison module in electronic communication with the Internet enabled mobile device receives feedback based on the results of the processing. Two-way communication is required to perform the decoding.

U.S. Pat. No. 9,286,631 discloses a system for management of age verification for delivery recipients. An Internet enabled mobile device is required. The system cannot function actively in a METRC system when Internet service is unavailable.

United States Published Patent Application No. 20170161750 discloses a system for identity authentication based on biometric information. The barcode reader must perform geometrical calculations in order to generate a value to compare with a library. This is undesirable in that many calculations must be performed.

United States Published Patent Application No. 20140279642 discloses a system for identity management using mobile imaging. Processing is performed on a captured image. Processing of the image is subject to the shortcomings of image processing described above.

United States Published Patent Application No. 20130112746 discloses an alcohol delivery management system for age verification using an internet enabled mobile device. Required processing cannot be performed by a stand-alone device at a delivery site.

U.S. Pat. No. 10,043,180 discloses a system for verifying personal data of a user at a location where payment is to be made. An Internet connection must be utilized in order to allow the transaction.

U.S. Pat. No. 10,121,041 discloses a barcode reader requiring formation of an image which is processed to decode information in the barcode. This patent presents an example of how an image must be processed. The barcode reader cannot read directly from a barcode before the image is produced.

The prior art does not disclose a simplified identification system for interaction with a comprehensive track and trace system which may perform its intended function without an Internet connection.

### SUMMARY

Briefly stated, in accordance with the present subject matter, an identification module and a subsystem including the identification module interact with an end-to-end track and trace system that traces a product or product component from its origin to an ultimate delivery recipient. An identification module comprises a live camera in a portable interactive device, e.g. a smartphone or a tablet, and an application that decodes identification indicia, particularly barcodes, directly from the live image sensor array rather than decoding from a still image. A CCD image sensor array produces a string of code characters in response to illumination of pixels. A camera in the scanner is operated at a frame rate that is a multiple of a nominal imaging frame rate of the camera. Operating parameters, e.g., scan rate, differing from the prior art are utilized. The subsystem translates the identification into an output provided to the track and trace system. The system cooperates in the track and trace system, reporting details of deliveries to the track and trace system. By providing accountability information at the end of the track and trace system, efficacy and accuracy of all the prior steps in the system are maintained.

### BRIEF DESCRIPTION OF THE DRAWINGS

The present subject matter may be further understood by reference to the following description taken in connection with the following drawings:

FIG. 1 is a diagram of a seed-to-sale system in which the present subject matter is employed;

FIG. 2 is an illustration of the delivery phase in the seed-to-sale track and trace system;

FIG. 3 is a diagram illustrating focusing of a camera on a barcode in a credential;

FIG. 4 is a block diagram of the system in which a scanning apparatus reads a barcode;

FIG. 5 is a diagram of architecture of an app, more particularly a non-transitory digital medium, for causing the apparatus to decode the barcode;

FIG. 6 is a flowchart of decoding and reporting data in a delivery subsystem;

FIG. 7 is a diagram of the communications network in which the operations of FIG. 1 are performed and in which the scanning apparatus reports to the track and trace system; and

FIG. 8 is a detailed diagram of the retail phase of the seed-to-sale track and trace system comprising stage 5 in FIG. 1.

### DETAILED DESCRIPTION

This system is discussed in the context of marijuana production and sales. The present subject matter is not limited to this application. Reliable track and trace systems are essential since state governments rigorously enforce regulations. A detailed chain of custody record must be maintained. If a dispensary fails at achieving full traceability, the significant effort at maintaining traceability may be lost at the end point of the track and trace process. Additionally, a dispensary may be subject to punitive regulatory action. This action may include fines, jail time, requirements to perform expensive auditable actions, and closing of the dispensary. In each of the flow charts below, steps need not necessarily be executed in the order illustrated. Steps only need be in the order shown where an alternative is logically impossible.

A track and trace system comprises a plurality of stages defining a path from origin to disposition. At an origin stage an initial input entity is identified. The input entity could comprise a quantity, a state, or other parameter which may change as the system proceeds from the origin to the disposition stage. Each stage comprising a register for entry of additions and reductions in the amount of the item or changes in state law. “State” in the present context means one of the United States or the District of Columbia.

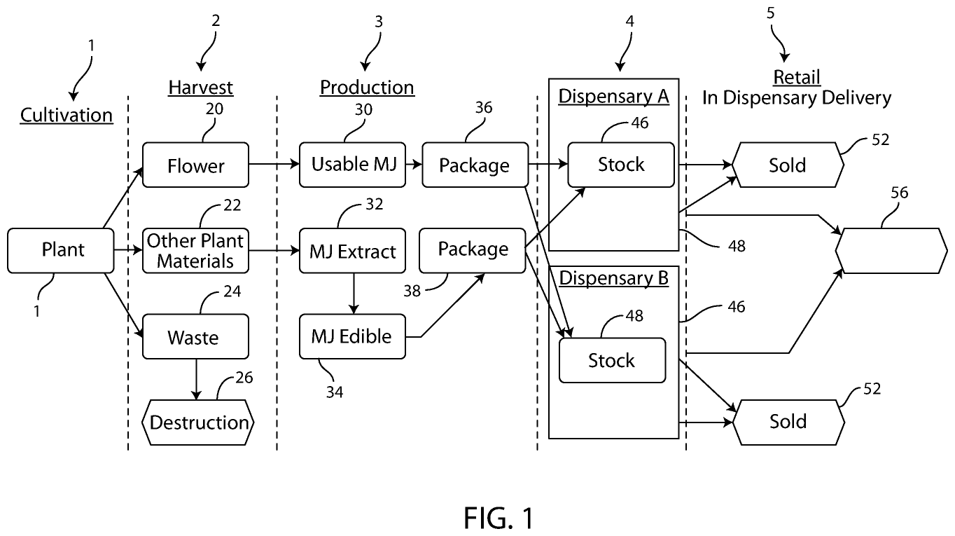

FIG. 1 is a diagram of a “seed-to-sale” track and trace system 14 incorporating the present subject matter. “Seed-to-sale” is a particular form of a “track and trace” system which maintains full accountability for products from a starting point through transformations through an end point. A significant “track and trace” reporting system is known as METRC (Marijuana Enforcement Tracking Reporting). In FIG. 1, the process of seed-to-sale tracking is illustrated in which the track and trace system 14 comprises a seed-to-sale METRC system 12. States may establish individual versions of a METRC system. The various systems are generally enabled to communicate with each other. The present diagram illustrates the importance of proper identification and record-keeping at the point of sale. The stages are cultivation 1, harvest 2, production 3, dispensary inventory 4, and customer and patient retail sale 5. In the present description, patient means a properly documented and authorized medical marijuana user having a prescription. Customer relates generally to individuals of age who may purchase products, but who do not have any special status. In the retail sale stage 5, a patient or customer consummates a sale at a dispensary or through an offsite delivery. The track and trace system 14 represents a tremendous investment in years of legislative activity, money, technology development, and refining the system in light of experience. If there is a failure of traceability in the retail sale stage 5, the seed-to-sale METRC system 12 ceases to fulfill its intended purpose. The present subject matter interacts with the track and trace system 14 to maintain integrity of the system.

Rigorous traceability begins in cultivation stage 1. A marijuana plant is inventoried and accounted for. At every further step, an inventory is maintained showing transformation of an item from one form to another and motion of an item from one place to another. Harvesting and replanting are examples of transformation and of motion respectively. Stage 1 begins at step 10. Plants are planted and cultivated in their initial location and in their initial form. Each plant is provided with a radio frequency identification (RFID) tag. RFID tags are loosely fastened to plants and may be read without touching the plants. After an initial inventory is established, identification protocols are followed at each continuing step.

Stage 2 begins with step 20 at which a flower is harvested. At a substantially contemporaneous time other plant materials are harvested at step 22. At step 24 remaining materials not collected at step 20 or step 22 are designated as waste. After step 24 destruction of the waste materials is performed at step 26. Quantities of harvested materials and waste are documented to provide a starting value of quantities of materials that will be used in stage 3.

In production stage 3 at step 30 plant flowers 20 are converted to usable marijuana. The production stage 3 may also include stocking at a distributor. At step 32, marijuana is extracted from the other plant materials. At step 34 extracts are combined in edible products. Usable marijuana is packaged at step 36. Edible products are packaged at step 38. All products are prepackaged before being sent to dispensaries. A predetermined amount of product is placed in each package, a label is prepared for the package, and the label is barcoded in order to document the quantity of product and other data, e.g., source. In this manner, known quantities of product may be sent to dispensaries. The label is also prepared with human-readable data including ingredients, strength, and producer identity. At the end of stage 3, quantities produced are reconciled with the starting value in order to maintain traceability.

In stage 4 usable marijuana is received at one or more dispensaries. In the present illustration, two dispensaries, dispensary A and dispensary B, are illustrated. In stage 4 deliveries of usable marijuana are made to the first dispensary A at step 46 and to the second dispensary B at step 48.

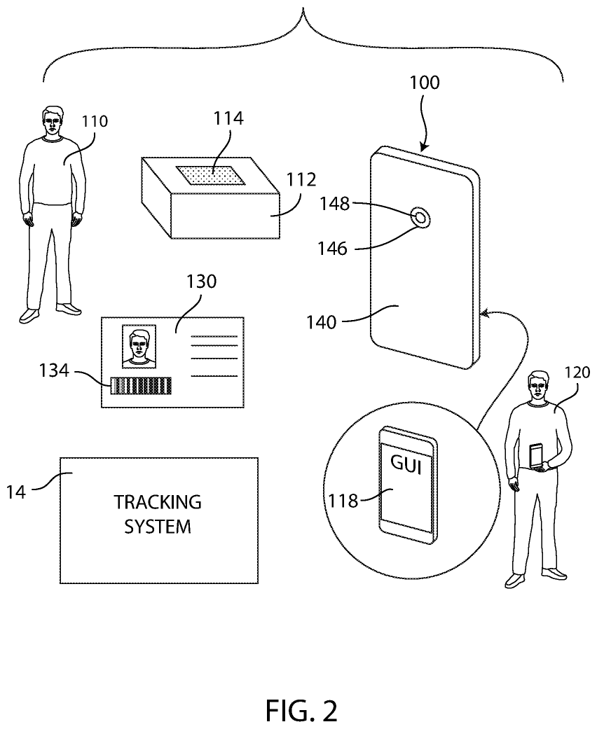

Stage 5 illustrates sale to recipients 120, e.g. customers and patients (FIG. 2) at a dispensary or via delivery. Sales at dispensary A and dispensary B are made at step 52. A sale may be initiated by receiving an online order at a dispensary server or in person. Deliveries are made to offsite customers 120 at step 56. At each stage data is reported to the METRC system.

FIG. 2 is an illustration of the delivery phase in the seed-to-sale track and trace system 14. In FIG. 2 a delivery person 110 delivers a package 112 that is being tracked in the seed-to-sale METRC system 12. The package 112 bears a barcode 114 uniquely associated with the package 112. The present subject matter is not limited to use with any one form of barcode. The barcode 114 could be a one-dimensional array, a two-dimensional QR code, or other code that can be resolved by a camera. Two-dimensional barcodes are generally preferred due to their capability to contain a vast amount of information. States encode many parameters into a code on a driver's license besides the driver's address, age, and type of license. Past driving history, organ donor status, and many other data fields are used. In one preferred embodiment, only PDF 417 bar codes are used. A form of credential called a Real ID is coming into use in the United States. This credential is also using PDF 417 bar codes.

The delivery person 110 deploys a scanning device 100 which interacts with the retail subsystem further described below. The subsystem comprises the structure performing a method to achieve the retail stage 5. This subsystem executes one stage of the seed-to-sale system. The retail location is a dispensary and the subsystem further comprises a dispensary server. The scanning device 100 reads the barcode 114 embodying encoded information uniquely associated with an order being delivered. The scanning device 100 comprises a camera 146 that focuses an optical image on an image sensor array. The camera 146 is operated as a video camera. An app 142 commands a frame rate that is a multiple of a nominal frame rate, defined below, associated with the camera. The scanning device 100 is a portable interactive device 102. The scanning device 100 interacts with the track and trace system 14 to perform tracking to complete the traceability of products to recipients. A preferred form of portable interactive device 102 is a smartphone 140 for reading encoded information. A portable interactive device 102 performs in a delivery phase of a seed-to-sale track and trace system.

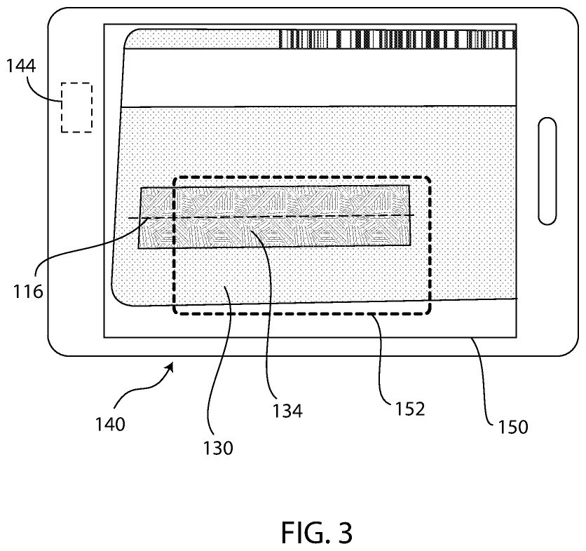

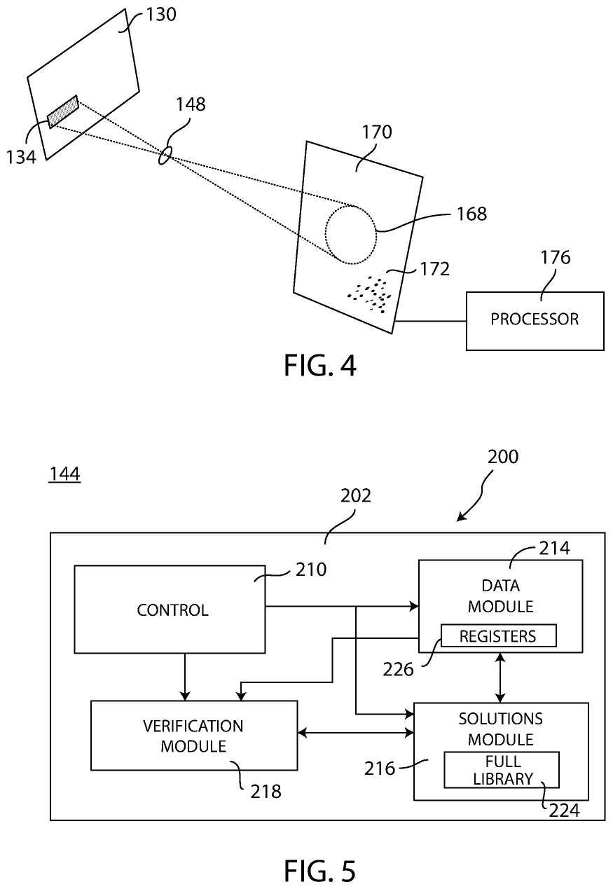

A recipient 120, e.g. customer, either non-medical or medical, is required to show to the delivery person 110 a credential 130 in order to verify the recipient 120's identity and the recipient 120's eligibility to receive the package 112. The credential 130 may include a driver's license or passport. The credential 130 includes a barcode 134. A prevalent form of eligibility information is the age of the recipient 120. The delivery person 110 deploys the smartphone 140 for reading encoded information. The smartphone 140 is equipped with the app 144 which is further described below. The app 144 may comprise a downloadable app. The smartphone 140 comprises a camera 146 having a lens 148. The lens 148 is pointed at barcode label 134 in order to focus the barcode on a pixel matrix 172 in a CCD image sensor array 170 (FIG. 4). Further features of the smartphone 140 are illustrated in FIG. 3.

FIG. 3 is a diagram illustrating focusing of the camera 146 (FIG. 2) on the barcode 134 in the credential 130. Many factors affect the efficacy of a smartphone scanner. The speed of barcode scanning is a function of how fast a camera can focus and adjust to light levels of the area including a barcode. Utilizing the mobile device 100's camera 146, the present subject matter scans the barcode 134 located on the credential 130, e.g. driver's license or ID card, to extract a person's information for the purpose of identity verification. Each state has its own protocol for encoding information in the barcode 134 and its own selection of information to be encoded.

The smartphone 140 has a viewing screen 150 on an opposite side of the smartphone 140 from the lens 148 (FIG. 2). The credential 130 bearing the bar code 134 appears on the screen 150. The camera 146 provides a viewer field 152. The viewer field 152 is used as a guide to assure that the camera 146 has been positioned so that the bar code 134 will be scanned. In the present illustration, the viewer field 152 is two-dimensional and may accommodate a two-dimensional bar code 134. In an alternate embodiment for scanning a one-dimensional barcode 134, the viewer field 152 may comprise a line 116. The delivery person 110 (FIG. 2) brings the smartphone 140 to focus on the viewer field 152. The line 116 is used to allow the user 110 to determine that the entire barcode is being read. At the completion of decoding, a graphical user interface (GUI) 118 (FIG. 2) is displayed on the viewing screen 150. Many functions may be reported via the GUI 118 to the delivery person 110. An important function is to report authorization or denial of the recipient 120 to the delivery person 110. The GUI 118 will commonly include pages showing maps, list of deliveries to be made, scheduling, record of reports to the dispensary, and status of reporting to the seed-to-sale METRC system 12. In each stage, the step of reporting to the seed-to-sale track and trace system comprises formatting data for reporting to a METRC system.

FIG. 4 is a diagram illustrating the physical reading of the barcode 134. The lens 148 focuses an optical image 168 of the barcode 134 on a charge coupled device (CCD) image sensor array 170 in the camera 146 (FIG. 3). The CCD image sensor array 170 comprises an array which is a pixel matrix 172. It is important to note that “image” in this context refers to the optical focusing of an object in a field of view onto pixels in a plane. An image of a barcode as referred to in the prior art descriptions comprises a saved set of values of pixels in the matrix at a point in time.

The embodiment of FIG. 4 allows for reading of pixels 172 directly before the pixels 172 are fixed in an image of the barcode 134. The CCD image sensor array 170 provides signal outputs to a processor 176 in the smartphone 140. The signal outputs are coupled for integration over a plurality of frame scans. The processor 176 integrates outputs of the CCD image sensor array 170 over a preselected time period to generate a string of characters indicative of encoded information Integrated signals are processed in a decoder in the processor 176 for correlation of the signals with code elements and extracting information from the string of characters. The processor 176 utilizes the app 144 (FIG. 2). Reading of the pixels 172 directly rather than reading an image of the barcode 134 avoids the existing problems of requiring an Internet connection, encountering fuzzy images, and glare in images. Often an Internet connection is not available, stops working, or is blocked in enclosed areas. This makes use of the Internet a limiting factor in successful decoding.

FIG. 5 is a diagram of architecture of the app 144, more particularly a program 200 embodied in a non-transitory digital medium 202, for causing the scanning apparatus 100 (FIG. 2) to decode the barcode 134. A common programming language to produce this sort of architecture is Apple Swift.

A control module 210 synchronizes operations. A data module 214 receives outputs from the CCD image sensor array 170 and evaluates and sorts signals to comprise the coded information corresponding to the barcode 134. A solutions module 216 processes data from the data module 214. The solutions module 216 decodes information embodied in the barcode 134.The solutions module 216 comprises a full library 224. “Full” denotes that the full library 224 may include any number of specialized libraries that are not articulated separately here. The solutions module 216 provides decoded information to registers 226 in the data module 214. A verification module 218 receives and evaluates decoded information with respect to delivery authorization criteria, and reports to the delivery person 110 via the GUI 118. In this way the delivery person 110 receives a definitive response in substantially real time.

The portable interactive device is coupled for reporting the delivery quantities to the retail location. A processor in the dispensary server 420 receives delivery information from the production stage to update a register in response to a signal indicative of an increase of quantities of the item at a retail location. The same processor is coupled to receive a signal indicative of an decrease of quantities in response to delivery of a quantity to a recipient. In this manner the retail location is enabled to reconcile inventory amounts with deliveries and returns. Reporting the delivery quantities from the delivery entity to the dispensary retail location from the scanning device 100 in the portable interactive device comprises a last step in the seed-to-sale track and trace system 14 prior to reporting to the state government. In this manner server quantities delivered to a recipient and quantities accounted for by the dispensary are reported to the seed-to-sale track and trace system which incorporates the retail stage subsystem. The scanning device is used to report deliveries that were not consummated and the products that will be returned via the delivery vehicle. The seed-to-sale METRC system 12 reconciles deliveries of products with reported remaining stocks at the dispensary A or dispensary B. The verification module 218 provides a mandatory information report to the state government via the seed-to-sale METRC system 12.

In the subsystem the dispensary server is coupled to receive data from the seed-to-sale track and trace system indicative of all quantities delivered to the dispensary. The dispensary server also receives information documenting all deliveries to a dispensary. The dispensary server is coupled to report all transactions to the seed-to-sale system, whereby the seed-to-sale system is enabled to complete accountability. In this manner the origin to disposition path is completed.

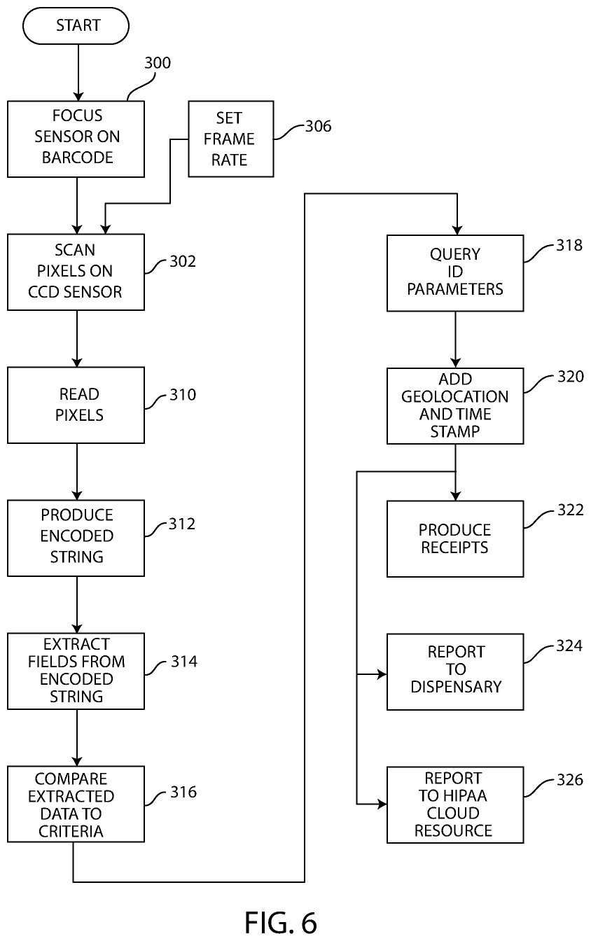

FIG. 6 is a flowchart of decoding and reporting data in a delivery subsystem performed by the app 144. Components referred to below are seen in FIG. 2. Operation begins at block 300 at which the camera 146 is focused on the barcode 134 via the lens 148. At block 302 the pixel matrix 172 in the CCD image sensor array 170 (FIG. 4) is scanned electronically. For purposes of illustration, the electronic scan frame rate is shown as being set at block 306. The frame rate selection may be built in to the scanner 100. By increasing the frame rate to a higher level than conventional scanning more data points can be captured. Capturing more information is significant since a 2D barcode may contain a vast amount of information. In one preferred embodiment, only PDF 417 bar codes are used.

The CCD image sensor array 170 which is in the camera 146 has a preselected frame rate. A preferred frame rate is selected with respect to a nominal frame rate for producing an image. The nominal frame rate is a performance specification of the camera 146. The preselected frame rate is selected as a predetermined multiple of the nominal frame rate. The frame used in the present subject matter is higher that the nominal rates for obtaining an image. For example, an iPhone® has a nominal frame rate of 30 frames per second. In an iPhone® 10, slow-motion video is taken at 240 frames per second. In an iPhone® 6, slow-motion video is taken at 120 frames per second. A camera in a Samsung Galaxy J7® smartphone has a nominal frame rate of 30 frames per second and an elevated frame rate of 60 frames per second. In one preferred embodiment using a camera 46 having a nominal frame rate of 30 frames per second, the frame rate for decoding is set at 60 frames per second. The frame rate can be increased up to the maximum rate available from a camera 46 included in the scanner 100. A fast scan rate is helpful particularly, for example, when many packages are being loaded into a delivery vehicle. Two factors are considered in determining a maximum desirable frame rate. Increased frame rate reduces battery life. Therefore, available resolution needs to be optimized versus battery life. Additionally, processing overhead or more expensive components may be needed to process frames at the highest rates.

The desired frame rate is described as a multiple of a nominal frame rate of the camera. The nominal frame rate is the manufacturer's specification. This rate is the normal scan rate for producing a regular video, i.e., not slow motion. The multiplier need not necessarily be an integer. One multiplier that has been proven is a factor of two. In other words in the above-identified smart phones with a nominal frame rate of 30 frames per second, a frame rate of 60 frames per second is used. Other multipliers may be used. Lower multipliers may be used, and results may be measured. Measurements are made in terms of whether required resolution is provided. Required resolution is a function of the code being read and the amount of data that needs to be recovered within one scanning period.

At block 310 the app 144 reads the pixel matrix 172 in the CCD image sensor array 170. At block 312 the barcode elements are detected and an encoded string of characters is obtained corresponding to the barcode 134. The string of characters produced comprises outputs of the pixel matrix 172. At block 314 fields of data are extracted from the string of characters. The processor 176 correlates the barcode elements with the intelligence contained therein. The string code is parsed by a function sent to correlate with the encoding protocol. The parsing may also include determination of the state from which information and criteria are issued.

When the camera 148 reads a full PDF417 barcode, the encoded string is obtained and the camera is closed. A “regular expression” regex decoding module is used in decoding encoded string from the scanning device 100. Fields are parsed according to American Association of Motor Vehicle Administrators (AAMVA) card design standards

The app 144 selects which of the many fields embodied in the barcode 134 will be used. Fields may include social security number, handicaps, class of driver's license, and address. The signals are formatted for processing rather than being assembled into an image. In this manner pixels in the pixel matrix 172 are read directly. Signal outputs of the pixel matrix are correlated with encoded data in the barcode. The disadvantages of reading an image are avoided. The present subject matter provides more reliable decoding than the prior art. At block 316 the extracted data is compared to stored criteria. Stored criteria may be contained in the full library 224 (FIG. 5). The full library 224 may be resident in the processor 176. Stored criteria may include, e.g., type of credential acceptable for verifying a recipient's identity and laws stating requirements that must be met to establish recipient's eligibility to receive the delivery and evaluating customer information to enable authorization of a sale. The barcode is read at the delivery entity independently of an Internet connection. Upon authorization the subsystem enters an order in the dispensary server.

At block 318 stored parameters are queried to register the results of comparisons made at block 316. The interpreted information is compared to fields containing criteria to provide a binary yes or no answer with respect to identity verification and authorization to receive a delivery by the recipient 120. Comparisons indicate whether the recipient 120 is eligible to receive a delivery. For example, in a representative state the current date compared to the recipient's 120 birthday must indicate at least an age of 18. For a customer, the comparison must indicate an age of 21. The system maintains a library of protocols within the full library 224 for selected states. The processor 176 is loaded with protocols which include criteria defining legal requirements for delivery and for reporting to the METRC system of the product for at least one state. At block 320 a geolocation and time stamp is entered in a field of current data. The interpreted information may be reported to the GUI 118. Interpreted information is also reported to the dispensary at block 324. At block 326 the report is also made to a HIPAA cloud resource for reporting to the government.

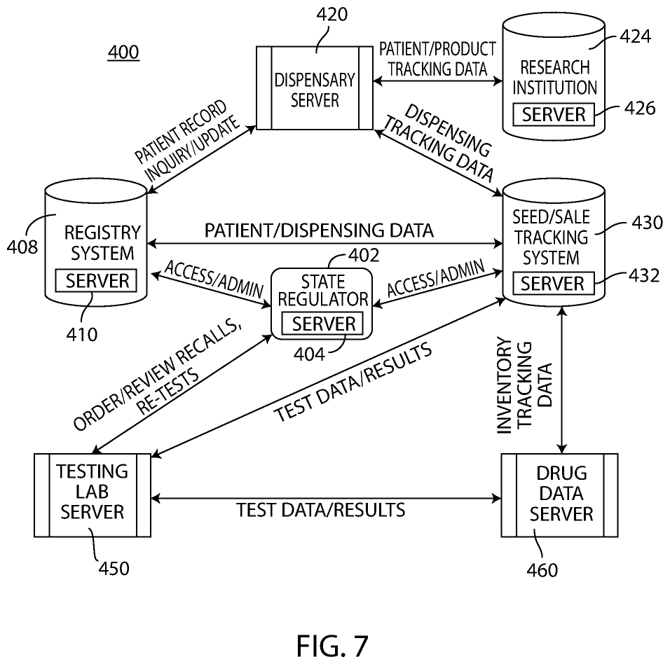

FIG. 7 is a diagram of a communications network 400 in which the operations of FIG. 1, including communication between servers, are performed and in which the scanning apparatus 100 reports to the seed-to-sale METRC system 12. The network 400 provides a network interconnection enabling complete traceability records to a government system 402 utilizing a government server 404. The network interconnection receives data from a production stage 3 of the track and trace system. A registry system 408 comprises a registry server 410. The registry system 408 is operated by a state government or a government contractor. The registry server 410 maintains communication with the government server 404 so that the state government can provide criteria to authorize or deny privileges A dispensary server 420 communicates with the registry server 410 for obtaining authorization information for a recipient 120 and providing update information regarding the recipient 120. The dispensary server 420 further communicates with a research institution 424 having a research institution server 426 to share patient and product tracking data. The dispensary server 420 also communicates with a seed-to-sale track and trace system 430 comprising a server 432 to report sales and returns. The seed-to-sale track and trace server 432 also receives results from the registry server 410 as well as a testing lab server 450 and a drug data server 460. The testing lab server 450 shares test results with the drug data server 460. Drug data server 460 shares data with the seed-to-sale track and trace server 432.

The drug data server 460 correlates testing lab information with inventory data. The data nominally includes strength of cannabis, additional ingredients, and suggested expiration date. The testing lab server 450 interacts with the state regulator server 404 to provide safety information, generate and review recall orders, and report on retests. This communications network 400 demonstrates the interaction of the dispensary server 420 with the entire seed-to-sale METRC system 12 of FIG. 1. This communications network 400 allows the dispensaries A and B, for example, via dispensary servers 420 to cooperate and have smooth interaction with the state regulator 402.

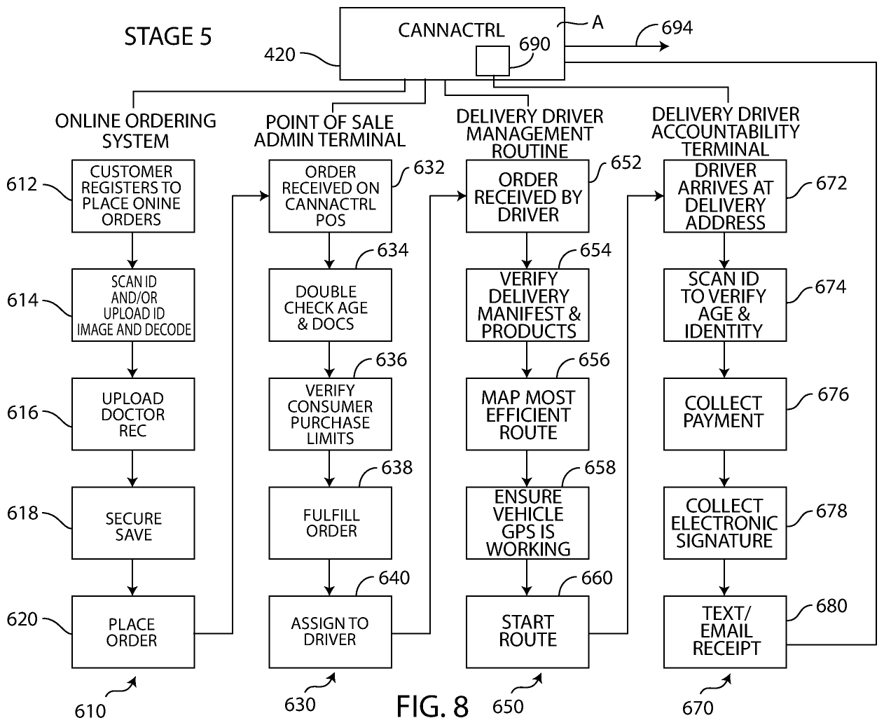

FIG. 8 is a detailed diagram of the delivery option in the retail phase of the seed-to-sale METRC system 12 comprising stage 5 in FIG. 1. Stage 5 is conducted from the dispensary server 420 at the dispensary A or dispensary B. The retail phase includes four modules. A first module is an online ordering system 610. A second module is a point of sale administrative terminal 630. A third module is a delivery driver management routine 650. A fourth module is a delivery driver accountability terminal 670. The scanner is operable in the fourth module.

In the online ordering system 610 a recipient 120 registers to place online orders at step 612. At step 614 the recipient 120 enters information from a credential such as by scanning a driver's license barcode 134 and decode ID and other information. During this step the decoded information will provide the recipient's age for comparison to legal requirements. A recipient that is underage will be rejected, and the process will end. At step 616 the recipient 120 enters a recommendation from a physician. This may be an optional or mandatory recommendation depending on the recipient's age and state law. The ID information is saved into a HIPAA-secure cloud database at step 618. At step 620 an order is placed and sent via the Internet to the point of sale administrative terminal 630 at the dispensary A, for example.

At the sales administrative terminal 630 an order is fulfilled. Delivery of the order is assigned to a delivery entity. At step 632 the order is received by the dispensary server 420. At step 634 the dispensary server 420 double checks the recipient's age and the recipient's credentials. The recipient purchase limits are compared at step 636 to preset thresholds before an order is taken. If the order is within the preset limits, the order is fulfilled at step 638. The product is entered into stage 5 of the seed-to-sale METRC system 12. When the order is filled, the dispensary prepares the order. Preparation includes inserting the product into an “exit bag.” The exit bag is childproof.

At step 640 the order is assigned to a delivery person 110. In the delivery driver management routine 650 the order is received by the server 420 and entered into a subroutine associated with one delivery person 110. The subroutine is used to store orders, order modifications, and other instructions to the delivery person 110. When the delivery person 110 is to begin a delivery route the delivery person 110 accesses the GUI 118 (FIG. 2) on the smartphone 140. The delivery person 110 receives the order for the recipient at step 652 via the GUI 118. The delivery driver management routine 650 provides utilities to the delivery person 110. The portable interactive device 102 comprises an interactive connection for receiving order information from the dispensary. At step 654 the delivery person 110 verifies a delivery manifest and products in order to be aware of any modifications that may have been made to the assigned schedule or assigned orders. The subroutine provides a map of a most efficient route at step 656. The global positioning system (GPS) device on a delivery vehicle is tested to assure that the delivery person can be tracked while on the delivery route. The route is started at step 660.

The delivery driver accountability terminal 670 monitors the delivery person on the delivery route. The order is transported to a recipient at a delivery address. The delivery person 110 arrives at the delivery address at step 672. During one step in the delivery process the delivery person saves a current geolocation, i.e., map coordinates, and time stamp. The delivery person rings the recipient's bell or otherwise makes his or her presence known. At step 674,the recipient 120 states intent to receive the package. The delivery person uses the scanner 100 to examine the recipient 120's credential 130 such as an official ID or driver's license using a smartphone 140 or tablet, for example, including the scanner 100. This examination may comprise scanning a barcode 134 on the credential 130 with a portable interactive device. In accordance with the present subject matter, the barcode 134 is read directly. An image of the barcode 134 is not generated first with the decoding being performed on the image. The barcode 130 is decoded utilizing the app 144. The lens 148 focuses the optical image 168 of the barcode 134 on the charge coupled device (CCD) image sensor array 170 in the camera 146 (FIG. 3). The CCD image sensor array 170 comprises the pixel matrix 172. This operation comprises focusing on the barcode to provide an optical image on the pixel matrix 172 in the image sensor array 170. It is important to note that “image” in this context refers to the optical focusing of an object in the field of view onto pixels in the plane. The image of a barcode as referred to in the prior art descriptions comprises a saved set of values of pixels in the matrix at a point in time., i.e., a “snapshot.”

The full library 224 (FIG. 5) contains information for evaluating data indicative of barcodes. In this manner information embodied in the barcode 134 is translated into usable form by processors and by humans. There is no need to access libraries via the Internet.

The app 144 reports eligibility of the recipient 120 to receive the delivery. It also verifies if the recipient 120 is not qualified to actually take possession of the product. This evaluation of barcode information serves to assure that the recipient 120 is the person who placed the order in the online ordering system module 610. Once the app 144 has established authorization, the authorization is reported to the delivery person 110 via the GUI 118. The portable interactive device further comprises the GUI 118 having selectable modes for interacting with the processor 176 to report authorization or denial of delivery to the recipient 120. At step 676 the delivery person collects payment and provides the product to the recipient 120 while contemporaneously collecting the recipient 120's electronic signature at step 678.

At a time when the cannabis industry will be entitled to use the banking system, payment may include payment by credit card as an option. At step 680 a delivery person transmits a digital receipt to the recipient 120. The receipt is sent by email or text, for example. At the same time the scanner 100 reports completion of the sale to the dispensary server 420 at step 690. The processor 176 reports to the dispensary, namely a dispensary server, the decoded quantities of all deliveries and returns, whereby the dispensary is enabled to reconcile all additions to inventory with all subtractions from inventory, and whereby the dispensary is enabled to report all required information to the seed-to-sale track and trace system. The portable interactive device is operable to report delivery parameters to the dispensary retail location.

The GUI 118 further interacts with the processor 176 to selectively display pages of reports to the dispensary and status of reporting to a METRC system. In this manner the delivery person 110 is informed of current information. Product that is not delivered must be returned to the dispensary of origin. The dispensary server 420 at step 694 transmits the data indicative of the sale to the track and trace system 14. In this way the dispensary retail location reports to the track and trace system for completing the origin to disposition path. In this manner the dispensary of origin fulfills its duties and maintains integrity of the seed-to-sale METRC system 12 within the track and trace system 14.

The scanner 100 reports to the dispensary of origin via the Internet. The retail stage subsystem method further comprises reporting from the delivery entity to the dispensary via the Internet. Should the Internet become temporarily unavailable, the scanner 100 will store the information and report to the dispensary of origin as soon as an interconnection is available. Even when reporting is disrupted the present subject matter is still fully capable of completing validation utilizing scanned barcode information. In this way the dispensary of origin fulfills its obligation to the state and earns the right to remain in business.

While the invention has been described in terms of various embodiments, those of ordinary skill in the art will recognize that the invention is not limited to the embodiments described but can be practiced with modification and alteration within the spirit and scope of the appended claims. The description is thus to be regarded as illustrative rather than limiting. Operations can be added to or deleted from any of the methods and information can be added or subtracted from any of the described messages without departing from the basic scope of the present invention. Any number of variations of the inventive concept are anticipated within the scope and spirit of the present invention. In this regard, the particular illustrated example embodiments are not provided to limit the invention but merely to illustrate it.

1. A track and trace system comprising:
a plurality of stages defining an origin to disposition path, each stage comprising a register for entry of additions and reductions in the amount of the item.
a network interconnection receiving data from a production stage of the track and trace system;
a processor receiving delivery information from the production stage to update a register in response to a signal indicative of an increase of quantities of the item at a retail location, said processor further being coupled to receive a signal indicative of a decrease of quantities in response to delivery of a quantity to a recipient;
a portable interactive device for communicating between the retail location and a delivery entity, said portable interactive device coupled for reporting the delivery quantities to the retail location;
a scanner for reading a barcode embodying encoded information uniquely associated with an order being delivered, said scanner comprising a camera within said portable interactive device that focuses an optical image on an image sensor array, the app commanding a frame rate that is a multiple of a nominal frame rate associated with the camera;
said image sensor array providing outputs coupled for integration over a plurality of frame scans and to provide output signals to said processor for correlation of the signals with code elements and extracting from the code elements information encoded into the barcode;
said processor further including in said app a library of criteria for verifying a recipient's identity and recipient's eligibility to receive the delivery, whereby the barcode is read at the delivery entity independently of an Internet connection;
said portable interactive device being operable to report delivery parameters to the dispensary retail location; and
said dispensary retail location reporting to the track and trace system for completing the origin to disposition path.

2. The subsystem according to claim 1 wherein the track and trace system comprises a seed-to-sale system.

3. The subsystem according to claim 2 wherein said library of criteria includes legal requirements for delivery of the product for at least one state.

4. The subsystem according to claim 3 wherein the library is executable by the processor to report quantities of deliveries or returns to said retail location whereby the retail location is enabled to reconcile inventory amounts with deliveries and returns.

5. The subsystem according to claim 1 wherein said track and trace system comprises a seed-to-sale track and trace system and wherein the retail location is a dispensary, the subsystem further comprising a dispensary server.

6. The subsystem according to claim 5 further comprising a first module being an online ordering system, a second module being a point of sale administrative terminal, a third module being a delivery driver management routine, and a fourth module being a delivery driver accountability terminal, the scanner being operable in the fourth module.

7. The subsystem according to claim 6 wherein said dispensary server is coupled to receive data from the seed-to-sale track and trace system indicative of all quantities delivered to the dispensary, the dispensary server receiving information documenting all deliveries to a dispensary, the dispensary server coupled to report all transactions to the seed-to-sale system, whereby the seed-to-sale track and trace system is enabled to complete accountability.

8. A retail stage subsystem method comprising:
receiving an online order at a dispensary server;
verifying identity of a customer and evaluating customer information to enable authorization of a sale;
upon authorization entering an order in the dispensary server;
fulfilling an order and assigning delivery of the order to a delivery entity;
transporting an order to a recipient at a delivery address;
scanning a barcode on a credential with a portable interactive device;
focusing on the barcode to provide an optical image on a pixel matrix in a CCD image sensor array in the portable interactive device;
producing a string of characters comprising outputs of the pixel matrix;
correlating signal outputs of the pixel matrix with encoded data in the barcode; and
reporting to the dispensary server quantities delivered to a recipient and reporting quantities accounted for by the dispensary to a seed-to-sale track and trace system incorporating said subsystem.

9. The retail stage subsystem method according to claim 8 wherein reporting to the seed-to-sale track and trace system comprises formatting data for reporting to a METRC system.

10. The retail stage subsystem method according to claim 9 further comprising reporting from the delivery entity to the dispensary via the Internet and storing the reporting data when Internet connection is not available, and reporting when an Internet connection becomes available.

11. A portable interactive device performing in a delivery phase of a seed-to-sale track and trace system comprising:
a smartphone comprising a camera and a lens, said lens focusing a barcode on a pixel matrix in a CCD image sensor array;
said CCD image sensor array having a preselected frame rate, the frame rate being selected as a predetermined multiple of a nominal frame rate of the camera, the nominal frame rate being a performance specification of the camera;
a processor integrating outputs of said CCD image sensor array over a preselected time period to generate a string of characters indicative of encoded information;
a decoder in said processor to extract information from the string of characters; and
a processor reporting to a dispensary the decoded quantities of all deliveries and returns, whereby the dispensary is enabled to reconcile all additions to inventory with all subtractions from inventory, and whereby the dispensary is enabled to report all required information to the seed-to-sale track and trace system.

12. The portable interactive device according to claim 11 further comprising a graphical user interface having selectable modes for interacting with the processor to report authorization or denial of delivery to the recipient.

13. The portable interactive device according to claim 12 wherein said graphical user interface further interacts with the processor to selectively display pages of reports to the dispensary and status of reporting to a METRC system.

14. The portable interactive device according to claim 13 wherein said processor is loaded with legal requirements for delivery and for reporting to the METRC system for at least one state.

15. The portable interactive device according to claim 11 comprising an interactive connection for receiving order information from the dispensary.
